(19) United States
(12) Patent Application Publication
(10) Pub. No.: US 2008/0199334 A1
(43) Pub. Date: Aug. 21, 2008

(54) Pump Assembly

(75) Inventor: Jesper Kok Sorensen, Kolding (DK)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Grundfos Management a/s, Bjerringbro (DK)

(21) Appl. No.: 11/913,801

(22) PCT Filed: Apr. 19, 2006
(86) PCT No.: PCT/EP06/03557

§ 371 Date: Nov. 19, 2007

(30) Foreign Application Priority Data
May 7, 2005 (EP) EP 05009985.2

(51) Int. Cl. F04D 13/06; F04B 17/03; H02K 1/27; H02K 5/16

(52) U.S. Cl. 417/423.7; 417/423.12; 310/156.01; 310/90

(57) ABSTRACT

A pump assembly with an electric drive motor is provided in which the rotor (10) is designed as a permanent magnet rotor. The rotor (10), at least in a part region of its axial extension (X), is formed as shaftless and made completely of a magnetizable material, and the magnet poles of the rotor (10) are formed by magnetization of the magnetizable material.

### CROSS-REFERENCE TO RELATED APPLICATIONS

This application is a Section 371 of International Application No. PCT/EP2006/003557, filed Apr. 19, 2006, which was published in the German language on Nov. 16, 2006, under International Publication No. WO 2006/119843 A1 and the disclosure of which is incorporated herein by reference.

### BACKGROUND OF THE INVENTION

The invention relates to a pump assembly as well as to a permanent magnet rotor for such a pump assembly.

Modem pump assemblies, in particular in the form of heating circulation pumps, often comprise electrical drive motors which are designed as permanent magnet motors. These permanent magnet motors comprise a rotor which is equipped with permanent magnets and which is set into rotation by way of suitably subjecting the stator coils to current. The known rotors have a central rotor shaft which is rotatably mounted on bearings, in particular sliding bearings, in the stator housing or on the stator. The actual rotor with the permanent magnets is fixed on the rotor shaft. For this, the individual permanent magnets may, for example, be arranged in recesses of the sheet lamination bundle, in whose central opening the rotor shaft is inserted. It is alternatively possible to surround the complete rotor shaft with a magnetizable material as a rotor, in which individual magnet poles are formed by way of a targeted magnetization.

These arrangements, on the one hand, have the disadvantage that in order to be able to realize adequately strong magnetic fields, they must have a certain minimum diameter, in order to be able to arrange or form adequately large magnets. On the other hand, the manufacturing and assembly costs for such rotors are quite large.

### BRIEF SUMMARY OF THE INVENTION

It is therefore an object of the invention to provide a pump assembly which permits a more compact construction of the drive motor and/or a more economical manufacture of the rotor, and thus of the whole pump assembly, by way of a compactly designed permanent magnet rotor.

This object is achieved by a pump assembly with an electric drive motor, which comprises a rotor designed as a permanent magnet rotor, wherein the rotor at least in a part region of its axial extension is designed in a shaftless manner and completely of a magnetizable material, and the magnet poles of the rotor are formed by magnetization of the magnetizable material. The object is also achieved by a permanent magnet rotor for such a pump assembly, wherein the rotor at least in a part region of its axial extension, is designed in a shaftless manner and completely of a magnetizable material, and the magnet poles of the rotor are formed by magnetization of the magnetizable material

The pump assembly according to the invention comprises an electrical drive motor which is designed as a permanent magnet motor. Accordingly, the electrical drive motor comprises a rotor which is designed as a permanent magnet rotor, i.e.,, the rotor comprises permanent-magnetic magnet poles which cooperate with the coils of the stator, such that the rotor is set into movement by way of subjecting the coils to current. As with known pumps, the rotor at its axial end is connected to the impeller of the pump assembly.

According to the invention, the rotor is designed such that at least in a part region of its axial extension, it is designed in a shaftless manner and completely from a magnetizable material. This means that in an axial part section of the rotor, preferably that region which is arranged in the inside of the stator, i.e., is surrounded by the stator coils of the drive motor, the rotor is designed such that it comprises no separate, central shaft, as is the case with known rotors. According to the invention, the rotor in this region is formed completely of magnetizable material, i.e., also the central region of the rotor in which otherwise usually a separate shaft is arranged, is formed of magnetizable material which thus as a whole assumes also the carrying function of the rotor. In the magnetizable material, the magnet poles of the rotor are formed in a permanent manner, i.e., permanently magnetically, by a way of a targeted magnetization of the material.

The arrangement according to the invention has the advantage that no effort-intensive assembly of the rotor from a multitude of individual parts is necessary, since the rotor at least in part regions may be manufactured as one piece from magnetizable material, for example sintered. The design has the further advantage that also the central region of the rotor consists of magnetizable material, so that either more magnetizable material is available in the rotor given the same rotor size, or the rotor may be designed smaller given the same magnetization, since the central region of the rotor may be utilized as magnetically effective material.

The complete rotor is particularly preferably designed as one piece from the magnetizable material. This permits a very economical manufacture of the rotor, since the complete rotor may be manufactured in one working passage, and an effort-intensive assembly of the rotor from individual parts may be done away with. The rotor for example may be pressed and sintered from magnetizable material.

Further preferably, the magnetizable material also forms at least one bearing surface of the rotor in the radial and/or axial direction. Thus the bearing surfaces of the rotor may also be designed as one piece with the complete rotor. The bearing surfaces, with oppositely lying bearing surfaces on the stator or stator housing, form sliding bearings, which are preferably fluid-lubricated if the drive motor is designed as a wet-runner, as is mostly the case with heating circulation pumps. The assembly and manufacture of the rotor and thus of the whole pump assembly may be further simplified and cheapened by way of the fact that no separate bearing elements need to be connected to the rotor. The magnetizable material is preferably a sintered material which has ceramic properties, so that the bearing surfaces have a sufficient hardness and wear resistance.

According to a further embodiment of the invention, at least one bearing surface of the rotor may be formed by a bearing bush connected to the magnetizable material, wherein the bearing bush is preferably pressed with the magnetizable material of the rotor. This embodiment is preferably preferred if special demands are made on the bearing material, if for example a harder or more wear resistant material is required for the bearing surface on account of the loading of a bearing. The bearing bush is preferably firmly and permanently connected to the rotor. This may, for example, be effected by way of pressing in the bearing bush at the same time as the pressing of the magnetizable material in the shape of the rotor. It is thus possible to connect the magnetizable material to the bearing bush in a permanent and firm manner on sintering the rotor.

Further preferably, stationary bearing surfaces of a ceramic material or carbon material cooperating with the bearing surfaces of the rotor are arranged in the pump assembly. These materials ensure a suitable material-pairing with the bearing materials of the bearing surfaces of the rotor.

A radially acting bearing surface of the rotor, i.e., a bearing surface extending peripherally around the outer periphery of the rotor concentrically to the rotation axis of the rotor, is preferably designed in a manner such that an annular deepening is formed at at least one axial end of the bearing surface at the outer periphery of the rotor. This deepening may be designed as a turned groove or countersink, and has the advantage that one may prevent a penetration of contamination into the bearing region, so that the life duration of the rotor bearing is increased.

According to a further special embodiment of the invention, a shaft stub extending away from the end, may be arranged on at least one axial end of the rotor. This shaft stub may serve for mounting the rotor and/or for example for connecting the rotor to the impeller of the pump. It is possible to mount the rotor on both axial sides via suitable shaft stubs. Alternatively, it is possible to design such a shaft stub only at one axial side, and to form bearing surfaces at the other axial side, as have been described above. Moreover, it is also possible to design such bearing surfaces and the shaft stub at the same axial end of the rotor, wherein the shaft stub, for example, merely serves for connecting the rotor to the impeller, but the mounting of the rotor is effected by the bearings surfaces described above. Such a shaft stub which may consist of a non-magnetic material, may be inserted into a suitable recess on the axial end-face of the rotor, wherein it is preferably pressed in and thus permanently held in with an interference fit. It is alternatively possible to also integrate the shaft stub on manufacture of the rotor, i.e., on pressing or sintering the rotor, such that the shaft stub is connected to the rotor or the magnetizable material of the rotor with a positive fit.

The magnetizable material of the rotor is preferably a ferrite material. The use of ferrite material has the advantage that this material is not prone to corrosion, so that one may also make do without an encapsulation of the rotor even with a drive motor designed as a wet-runner. Furthermore, the ferrite material has such ceramic properties which also render it suitable as a bearing material, so that, as described above, bearing surfaces of the rotor for the sliding bearing of the rotor may be designed directly on the surface of the magnetizable material, i.e., the bearing surfaces likewise consist of this material.

Preferably, at least one radially and/or axially extending bleed channel is formed in the rotor. Such a channel may for example extend centrally in the rotor in a continuous manner from one axial end side to the opposite axial end-side. Alternatively, the channel may be designed such that it is also opened to the periphery of the rotor by way of radially extending channels. The bleed channel serves for bleeding the gap between the rotor and the stator on starting operation of the pump assembly, so that this gap may then be filled by the fluid to be delivered, in particular water.

Alternatively or additionally, at least one bleed groove, which extends preferably in a helical manner over the periphery of the rotor, may be formed on the outer periphery of the rotor. Thereby, the bleed groove does not need to extend over the whole periphery of the rotor in a helical manner, but rather may extend with a correspondingly large pitch only over a part region of the rotor periphery. Thereby, the groove extends preferably from one axial end-side to the opposite axial end-side of the rotor. Thus, the groove may ensure the bleeding of the complete gap between the rotor and the stator on starting operation of the pump assembly.

The drive motor of the pump assembly is preferably designed as a canned motor with a can of stainless metal or plastic, which seals the stator with respect to the fluid-filled inner space of the drive motor.

With this design, it is possible for the can at its inner periphery to have a bleed groove extending in a preferably helical manner. This groove too further preferably extends from one axial face-end to the opposite axial face-end of the stator or can, so that a bleeding of the gap between the rotor and the can, to the impeller of the pump is possible. Thereby, the groove may for example extend wound in a helical manner over a part region of the inner periphery of the can. It is also possible to design several grooves in the can distributed over the periphery.

Particularly preferably, only the region of the rotor which lies radially opposite the stator of the drive motor is magnetized for forming the magnet poles, in the magnetizable material of the rotor. This means that the magnet poles, which are necessary for operation of the motor, are only formed in the region of the rotor, which lies opposite the inner periphery of the stator. Thus, only that part of the rotor which is influenced by the stator magnetic field, is actually magnetized.

Further preferably, the rotor comprises a magnet pole preferably at an axial end of the rotor, and this magnet pole is produced by magnetization of the magnetizable material and is part of a rotation angle sensor. Such rotational angle sensors are applied with permanent magnet motors to detect the rotor position, in order to be able to subject the stator coils to current in dependence on the angular position of the rotor. For this, one may for example apply a Hall sensor which detects the field of a magnet pole in the rotor. One may use the magnet poles for this, which serve for the drive of the rotor. The Hall sensor is, e.g., arranged in the region of the can with this arrangement. This however is not always possible, so that it may be preferable to arrange the Hall sensor in the region of the axial end of the rotor. Thereby, with the single-piece rotor of magnetizable material according to the invention, it is also possible by way of magnetization, to very simply form one or more magnet poles in a region of the rotor which does not lie in the inside of the stator, which are merely envisaged for the magnetic sensor, in particular for the Hall sensor for detecting the rotor angular position.

According to a particular embodiment, the rotor has a constant outer diameter over its whole axial length. This means that the rotor is designed cylindrically with a constant cross section without steps on the outer periphery. This permits a very inexpensive manufacture of the rotor, since the outer peripheral surface of the rotor may be continuously machined, for example ground in one working passage. Notch stresses in the rotor are further avoided.

Apart from the previously described pump assembly, a permanent magnet rotor for such a pump assembly is also the subject-matter of the invention. According to the invention, this permanent magnet motor is shaftless and completely formed of a magnetizable material at least in a part region of its axial extension, preferably however over its whole axial extension. This means that no separate rotor shaft is provided in the inside of the rotor and the magnetizable material is simultaneously the carrying part and serves for torque transmission. The magnet poles of the rotor, which form the permanent magnets of the permanent magnet rotor, are formed in the rotor in a permanent manner by way of the magnetization of the magnetizable material. Such a permanent magnet rotor comprises the advantages described above with regard to the whole pump assembly. Furthermore, this permanent magnet rotor may have the preferred designs described above by way of the pump assembly.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a sectional view of a first embodiment of the pump assembly according to the invention,

FIG. 2 is a sectioned, detailed view of the can and of the rotor of a pump assembly according to the invention,

FIG. 3 is a sectioned view of the can and of the rotor according to a further embodiment of the invention,

FIG. 4 is a sectioned view of the can and of the rotor according to a further embodiment of the invention,

FIG. 5 is a sectioned view of the can and of the rotor according to a further embodiment the invention,

FIG. 6 is a sectioned view of the can and of the rotor according to a further embodiment of the invention,

FIG. 7 is a sectioned, exploded view of the can and of the rotor according to one embodiment of the invention,

FIG. 8 is a sectioned view of a can and a rotor according to the invention, with two alternative rotors,

FIG. 9 is a sectioned, exploded view of a can and the rotor according to an embodiment of the invention, with an alternative rotor,

FIG. 10 is a sectioned exploded view of a can and a rotor according to a further embodiment of the invention, and

FIG. 11 is a sectioned view of the can, rotor and impeller according to a further embodiment of the invention.

### DETAILED DESCRIPTION OF THE INVENTION

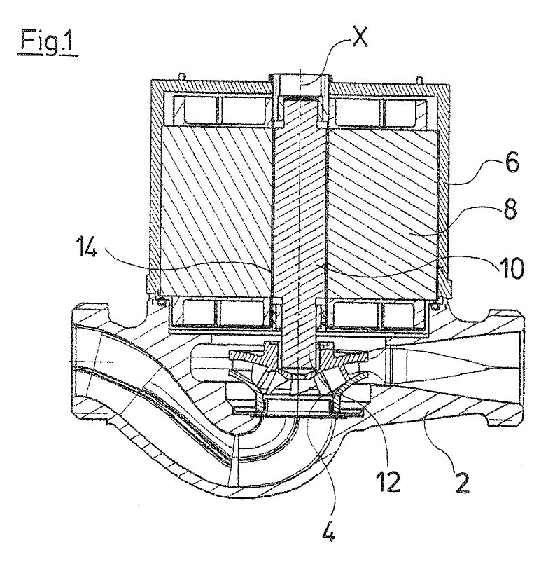

The basic construction of the pump assembly according to the invention or of the permanent magnet rotor according to the invention is basically explained by way of FIG. 1, which shows a cross-section view of a heating circulation pump. The shown pump assembly, as essential components, comprises a pump housing 2 with an impeller 4 arranged therein. The pump housing 2 is connected to a stator housing 6, in which the stator 8 of the drive motor of the pump assembly is arranged. The stator 8 in the known manner comprises several stator windings. The rotor 10 according to the invention, which is designed as a permanent magnet rotor, is arranged in the stator 8. The rotor 10 extends with its first axial end 12 into the pump housing 2 and there is connected to the impeller 4 in a rotationally fixed manner.

The rotor 10 is arranged in the inside of the stator 8 in a can 14 which seals the stator with respect to the inner space in which the rotor 10 is arranged, and with respect to the pump housing 2. This means that the drive motor is designed as a wet-runner with which the gap between the rotor and the stator 8 or the can 14 is filled with the fluid to be delivered, in particular water.

According to the invention, the rotor 10 is designed completely of a magnetizable material in which the permanent-magnetic magnet poles of the rotor are formed by way of a targeted magnetization. This means that the rotor as a whole is designed essentially as one piece, and comprises no separate central shaft. Thus above all, in the region of the rotor which lies in the inside of the stator 8, the complete rotor diameter is available as a magnetizable material, so that a greater magnetization of the rotor may be achieved with the same rotor diameter, or a smaller rotor diameter with the same magnetization.

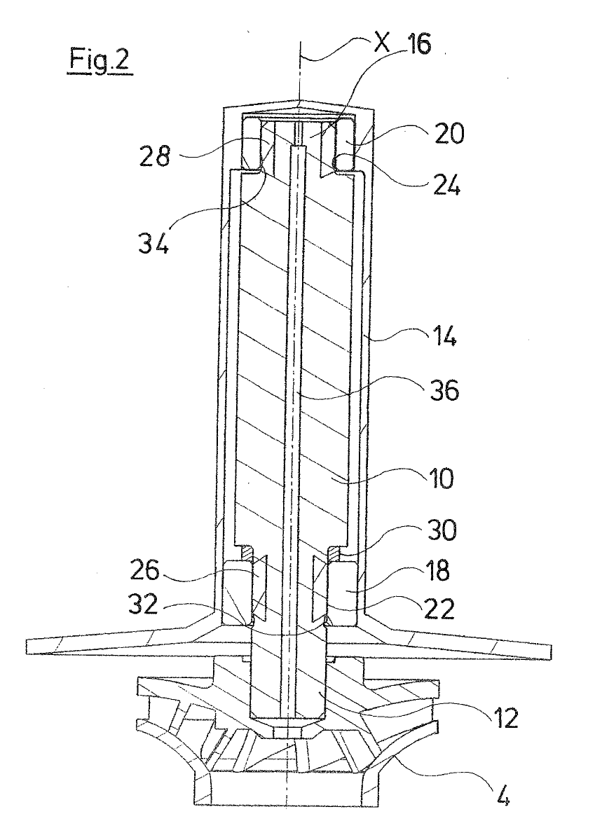

Individual embodiments of the rotor constructed according to the invention are explained in more detail by way of the FIGS. 2 to 6, which in each case show only a cross section of the can 14 with the rotor 10 arranged therein and the impeller 4 of the pump attached thereon.

According to a first embodiment of the invention, which is shown in FIG. 2, the rotor 10 is essentially formed of one piece of magnetizable material, for example of a ferrite material. The rotor is in each case designed in a tapered manner in the region of its axial ends 12 and 16, and there is mounted in the can 14. The rotor at the axial end 12 is further connected to the impeller 4 as is already described by way of FIG. 1. Bearing bushes 18 and 20 are arranged as bearings in the known manner in the inside of the can 14, and are formed for example of ceramic or carbon material. These bearing bushes 18 and 20, with oppositely lying bearing surfaces on the outer periphery of the axial ends 12 and 16 of the rotor 10, form sliding bearings which guide the rotor in the radial and axial direction. The sliding bearings thereby are lubricated by the fluid to be delivered, in particular water.

In the example shown in FIG. 2, the bearing surfaces 22 and 24 are designed as bearing bushes 26 and 28 integrated into the rotor 10. The annular bearing bushes 26 and 28 thereby have a swallow-tail shaped cross-sectional shape in a cross sectional plane extending in the direction of the rotation axis or longitudinal axis X of the rotor, and this shape creates a positive-fit connection to the magnetizable material of the rotor 10. The bearing bushes 26 and 28 are pressed and/or sintered with the magnetizable material on manufacture of the rotor 10 from the magnetizable material, so that they are connected to the magnetizable material of the rotor 10 in a permanent and firmly integral manner. The bearing bushes 26 and 28 are manufactured of a suitable bearing material, for example of a ceramic material or of a carbon-containing material. This embodiment with inserted bearing bushes 26, 28 is preferred in the case that the bearing material needs to have properties different from the magnetizable material of the rotor 10.

The two mountings at the two axial ends 12 and 16 of the rotor 10 both serve for radial mounting. The axial mounting is assumed on operation essentially by the bearing bush 18, since the axial forces which occur on operation of the pump are directed in the direction of the pump housing 2 or of the impeller 4. Thereby, the end-side of the bearing bush 18 which is distant to the impeller 4 and on which an intermediate ring 30 of an elastomeric or carbon material bears, serves as an axial bearing surface.

Furthermore, in each case peripheral deepenings or recesses 32 and 34 are formed on the bearing surfaces 22 and 24 at the ends which face the impeller 4, and these recesses form annular grooves on the outer periphery of the rotor 10 in the region of the axial end of the bearing surfaces 22 and 24. The recesses or grooves prevent a penetration of contamination which may be contained in the fluid to be delivered, into the bearing gap between the bearing surface 22 and the bearing bush 18, or the bearing surface 24 and the bearing bush 20.

The rotor 10 according to the embodiment which is shown in FIG. 2, furthermore comprises a central bleed channel 36 which extends over the whole axial length of the rotor 10 centrally along the rotation axis X and is opened towards the two axial end-sides of the rotor 10. The bleed channel 36 runs out at the end-side on the axial end 12 of the rotor 10 centrally in the impeller 4 and thus faces the suction port of the pump. In this manner, the channel 36 on starting operation of the pump may bleed the region between the rotor 10 and the can 14, which is distant to the impeller 4, so that the gap between the rotor 10 and can 14 may be completely filled with the fluid to be delivered.

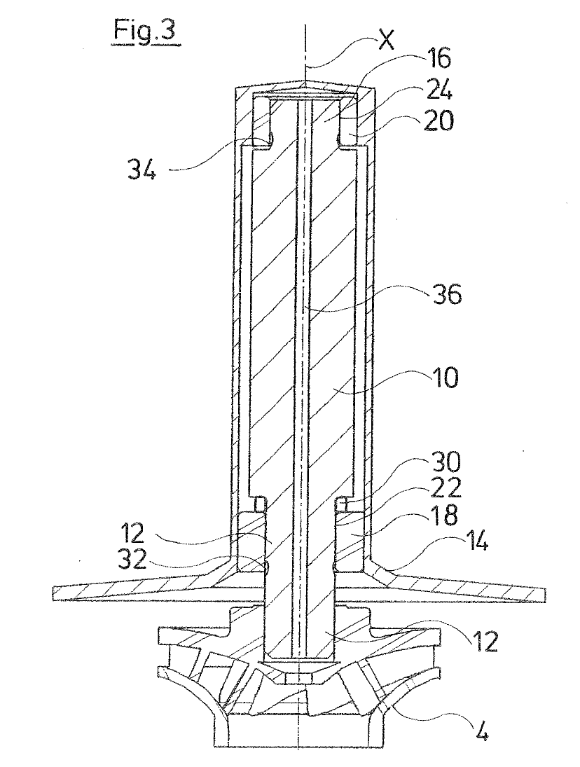

FIG. 3 in a view according to the view shown in FIG. 2, shows a second embodiment of the invention. This embodiment differs from the embodiment shown in FIG. 2 in that one does away with the bearing bushes 26 and 28 in the rotor 10. This is possible if the magnetizable material of the rotor 10 itself has properties, which render it suitable as a bearing material for the bearing surfaces 22 and 24. If necessary, a surface treatment of the magnetizable material of the rotor 10 may be carried out in the region of the bearing surfaces 22 and 24, in order to produce the required hardness or strength of the material, as well as the necessary sliding properties. A ferrite material, for example is suitable. Such a ferrite material essentially has the same properties as a ceramic material so that it is directly suitable as a bearing material. Furthermore, ferrite further has the advantage that it is insensitive to water and therefore may be applied into a wet-runner without additional encapsulation on the outer periphery of the rotor 10. The bearing surfaces 22 and 24 cooperate with the bearing bushes 18 and 20 in the can 14, as described by way of FIG. 2. All other features of the embodiment according to FIG. 3 correspond to the features already described by way of FIG. 2.

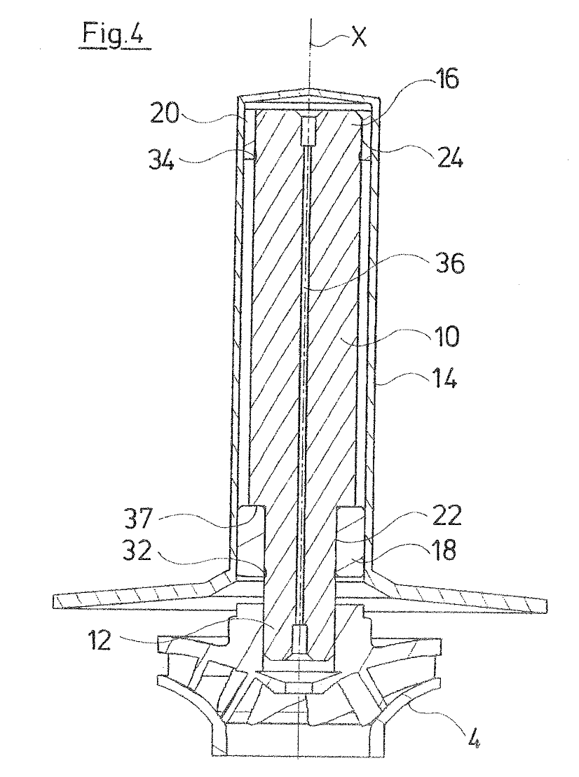

A further embodiment of the rotor 10 according to the invention is described by way of FIG. 4. The embodiment according to FIG. 4 differs from the embodiment according to FIG. 3, in that the rotor at its axial end 16 is not designed in a stepped manner, but has a constant cross section which corresponds to the cross section of the rotor 10 in its middle region, i.e., the region situated in the inside of the stator 8. Only the axial end 12, which faces the impeller 4, is designed in a stepped manner, as with the previously described embodiments. The omission of the steps or shoulders of the rotor 10 in the axial direction permits a simpler surface machining of the outer periphery of the rotor 10 and thus a simpler manufacture of the whole rotor 10.

A further difference of the embodiment according to FIG. 4 to the embodiments described before, lies in the fact that one does away with the intermediate ring 30, i.e., the axial bearing with the embodiment according to FIG. 4 is formed by the direct bearing of the rotor 10 on the axial end-side of the bearing bush 18 which is distant to the impeller 4. Thereby, the rotor 10, with an axial abutment shoulder 37 formed by the tapering of the rotor diameter towards the axial end 12, comes to bear on the bearing bush 18. The remaining features which are shown in FIG. 4, correspond to the features explained by way of FIGS. 2 and 3.

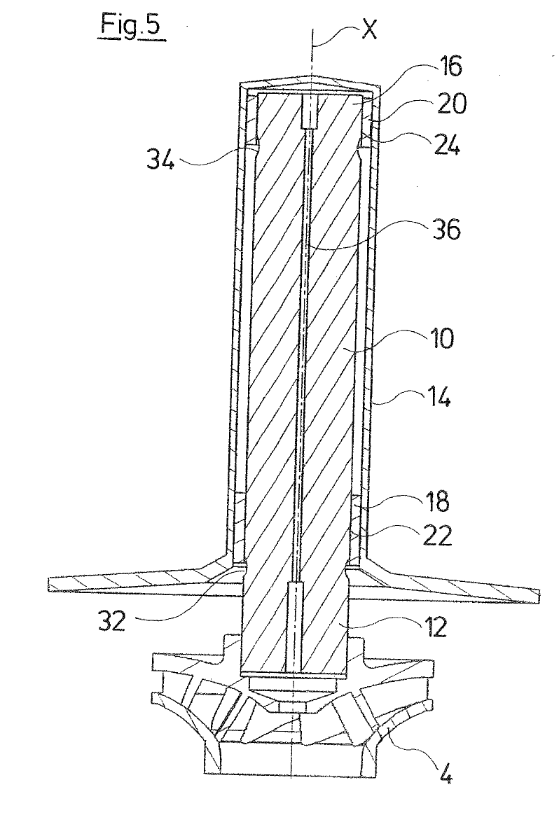

FIG. 5 shows a further embodiment of the rotor 10 according to the invention, which is formed with a constant cross section or diameter over its whole axial length, i.e., in contrast to the embodiment according to FIG. 4, one makes do without the stepping to the axial end 12 which faces the impeller 4 with the embodiment according to FIG. 5. Such a design of the rotor permits a particularly simple machining of the outer periphery of the rotor, since the rotor for example may be ground on its outer periphery in a run-through procedure.

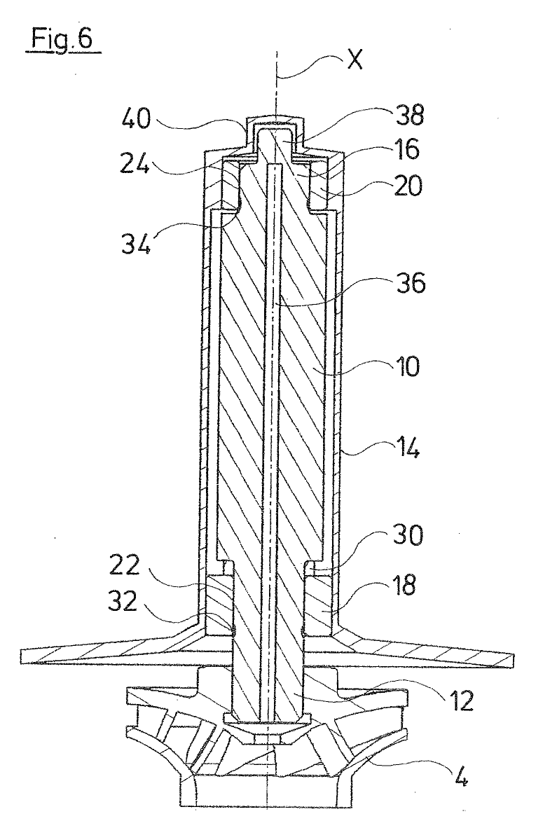

FIG. 6 shows a further embodiment of the rotor according to the invention. This rotor corresponds essentially to the rotor shown in FIG. 3, with the difference that the rotor 10 comprises an axial extension 38 at its axial end 16, i.e., the end which is distant to the impeller 4. The axial extension 38 which extends concentrically to the rotation axis X, projects into an axial-side protuberance 40 of the can 14. The axial extension 38 serves for cooperation with a magnetic field sensor, for example a Hall sensor, which may be arranged on the outer periphery of the protuberance 40, i.e., outside the can 14. One or more magnet poles may be formed in the axial extension 38 by way of magnetizing the magnetizable material, of which the whole rotor 10 consists, and these magnet poles may be detected by way of a magnetic field sensor which is arranged outside the can 14 in the region of the protuberance 40. The angular position of the rotor may be detected in this manner, which is necessary with regard to subjecting the stator coils to current. This embodiment form is suitable for cases of application in which a corresponding sensor may not be arranged in the region of the stator coils, in order to detect the magnet poles of the rotor 10 which are formed in this region.

With the embodiment shown in FIG. 6, the bleed channel 36 is not formed up to the axial end-side at the axial end 16. Rather, with this embodiment, one provides radially extending channels which are open to the outer periphery of the rotor 10. These channels are not shown in FIG. 6 and are yet to be explained by way of the following Figures.

The remaining features shown in FIG. 6 correspond to the features explained by way of FIGS. 2 to 5.

The features and embodiments of the rotor 10 according to the invention which are shown in the FIGS. 2 to 6 may also be combined with one another in a different manner. It is thus for example possible to arrange bearing bushes 26 and 28 in the rotor 10 also with a rotor with a constant diameter over the whole axial length, as is shown for example in FIG. 5. Furthermore, one may also provide an axial extension 38 as is shown in FIG. 6, with the embodiments shown in the FIGS. 2 to 5. Here too, the arrangement of the intermediate ring 30 is possible with the embodiments with which the intermediate ring 30 is not shown. It is further possible to provide only one of the bearing bushes 26 and 28, for example in the bearing of the rotor 10 which faces the impeller 4. The other bearing surface 24 may be formed by the magnetizable material of the rotor 10.

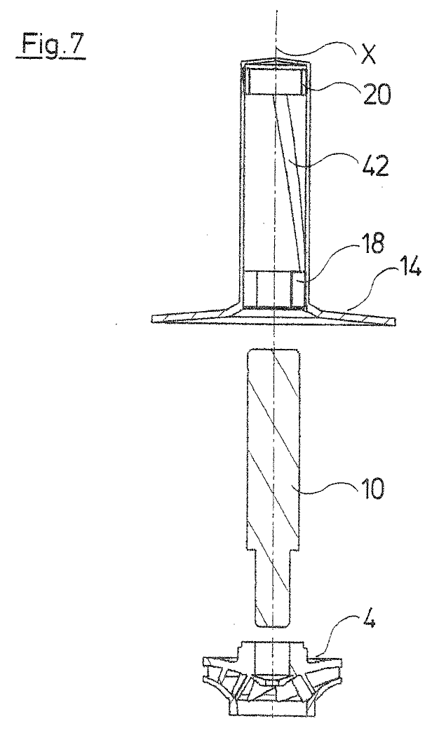

Hereinafter, different designs of bleed channels and bleed grooves for bleeding the rotor gap between the rotor 10 and the can 14 are explained by way of the FIGS. 7 to 10 which show detailed views of rotors 10, as have been described by way of FIGS. 2 to 6.

FIG. 7 shows a can 14 with a rotor 10 and impeller 4 according to the embodiment of the invention shown in FIG. 4. In contrast to the rotor 10 shown in FIG. 4, the rotor 10 according to FIG. 7 comprises no central bleed channel 36. Instead of this, bleed grooves 42 are formed extending in a helical manner on the inner periphery of the can 4, of which only one is shown in FIG. 7. Preferably, two bleed grooves 42 are formed on diametrically opposite sides of the can 14. The bleed grooves 42 extend over the axial length in the direction of the rotation axis X of the can 14 and thereby are wound over the periphery, so that a helical or oblique course arises, wherein the grooves 42 do not need to extend over the whole inner periphery of the can 14. The bleed grooves 42, as also the previously described bleed channel 36, serve for bleeding the gap between the can 14 and the rotor 10 on starting operation of the pump assembly, and filling this region completely with the fluid to be delivered, for example water, so that the motor runs as a wet-runner.

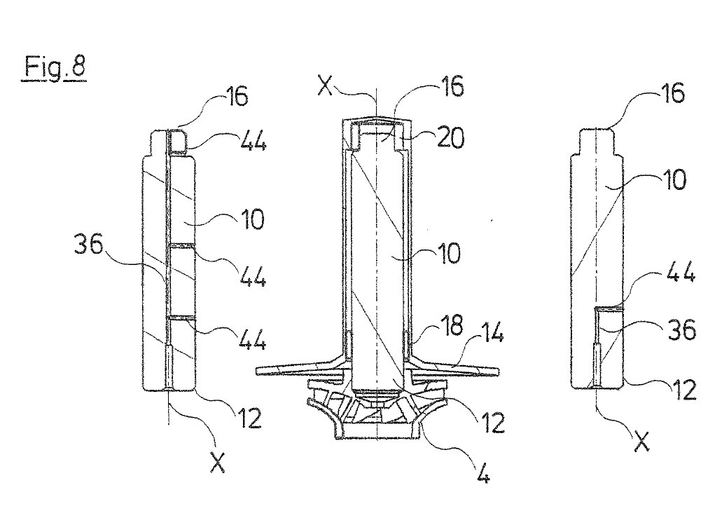

FIG. 8 shows a further embodiment of the rotor 10 according to the invention. The arrangement of the rotor 10 in the can 14 with the impeller 4 is shown in the middle in FIG. 8. Thereby, the arrangement corresponds essentially to that design described by way of FIGS. 3 to 6, only that in contrast to the embodiment according to FIG. 4, it is not the axial end 12 which is designed tapered in diameter, but the axial end 16 which is distant to the impeller 4. Two different rotors 10 with a different design of the bleed channels 36 are represented on the left and right in FIG. 8. With the example shown on the left in FIG. 8, the bleed channel 36 extends from the axial end 12 towards the axial end 16 of the rotor 10, i.e., from end-side to end-side in the direction of the rotation axis X. Additionally, proceeding from the cannel 36, channels 44 extend in the radial direction toward the peripheral surface of the rotor 10.

With the example shown on the right in FIG. 8, the channel 36 proceeding from the end-side at the axial end 12 extends in the direction of the rotation axis X, only up to into the central region of the rotor 10, but not to the axial end 16. A channel 44 from the end of the bleed channel 36 which is distant to the axial end 12, extends in the radial direction to the peripheral surface of the rotor 10. Even if the radially extending channels 44 only are shown to one side in FIG. 8, it is possible to arrange several channels 44 which extend in different radial directions, i.e., at angles to one another.

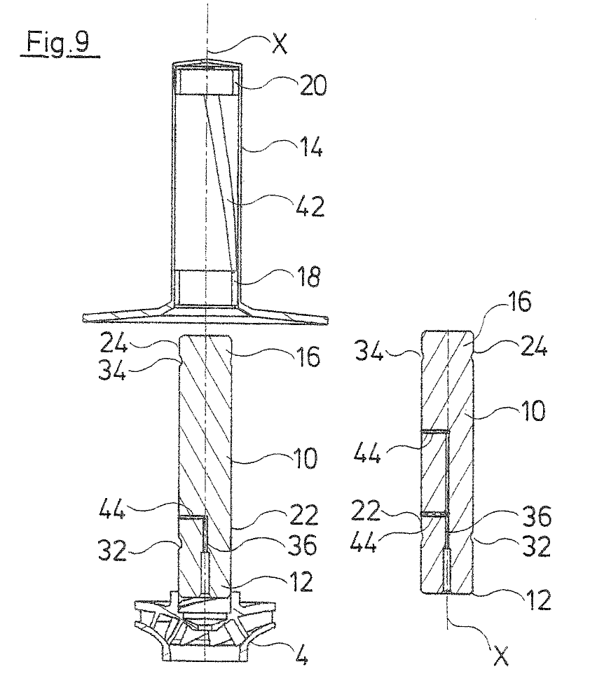

FIG. 9 shows a rotor 10 with an impeller 4 and a can 14, as well as an alternative design of the rotor 10 at the right in FIG. 9. Basically, the rotor shown in FIG. 9 corresponds to that rotor described by way of FIG. 5, with the difference that the bleed channel 36 in the rotor 10 essentially has the course described by way of FIG. 8. The course of the bleed channel 36 shown on the left in FIG. 9 with the radially extending channel 44 corresponds to the channel course represented on the right in FIG. 8. One embodiment is shown on the right in FIG. 9, with which the bleed channel 36 extends in the direction of the rotation axis X from the end-side at the axial end 12 of the rotor 10 into the inside of the rotor 10, but not up to the opposite end-side at the axial end 16. Channels 44, proceeding from the central channel 36, extend in the axial direction X radially outwards at a distance, to the outer periphery of the rotor 10.

With the embodiment according to FIG. 9, a bleed groove 42 or several bleed grooves 42 are additionally formed in the can 14, as is described by way of FIG. 7.

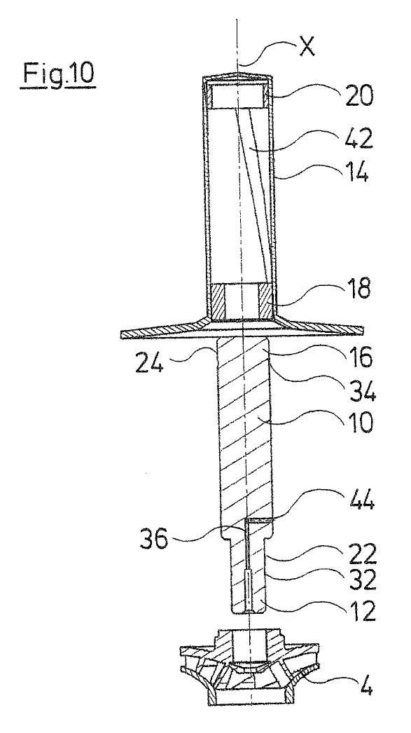

FIG. 10 shows a can 14 with a rotor 10 and impeller 4 according to the embodiment shown on the left in FIG. 9, wherein however the rotor 10 with respect to its steps on the outer periphery, is designed corresponding to the embodiment described by way of FIG. 4.

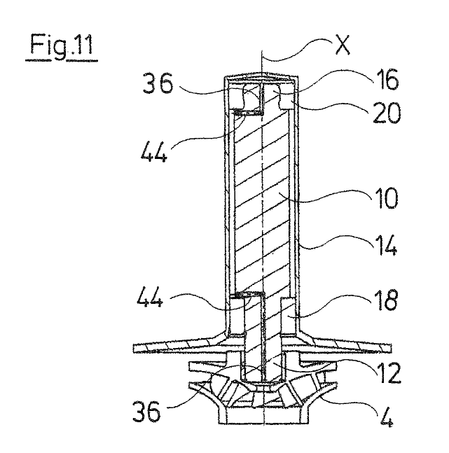

FIG. 11 shows a further embodiment of the arrangement of the channels 36 and 44, wherein the design of the rotor 10 basically corresponds to the construction described by way of FIG. 3, but the intermediate ring 10 has been omitted similarly to the embodiment shown in FIG. 4. With the embodiment according to FIG. 11, in each case a central channel 36 extends in the direction of the rotation axis X from the end-sides at the axial ends 12 and 16, into the inside of the rotor 10. Thereby, the channels 36 however only extend up to the border of that region of the rotor 10 which is arranged in the stator 8, i.e., only up to the border of the region, in which the magnet poles of the rotor 10 are formed by magnetization. In each case, channels 44 extend from the ends of the channels 36 which are situated in the inside of the rotor 10, outwards in the radial direction towards the peripheral surface of the rotor 10, and run into the gap between the rotor 10 and the can 14. The gap between the rotor 10 and the can 14 and also the gap at the axial end 16 between the rotor 10 and the can 14 may be completely bled by way of these channels 36 and 44 on starting operation of the drive motor. The rotor 10 however is free of channels in the region of the rotor 10 which lies in the stator 8 and is magnetically effective, so that the rotor here is formed in a solid manner of the magnetizable material. Thus the complete rotor 10 or its complete volume may be magnetized in this region, so that the maximal possible strength of the magnetic fields of the magnet poles in the rotor 10 may be achieved with the rotor volume which is available.

With regard to the courses of the bleed channels 36 and 44, as well as of the bleed grooves 42 on the can 14, which are described by way of FIGS. 7 to 11, one should note that these embodiments may also be combined with designs which are different to those shown designs of the rotor 10. Thus the courses of the channels and grooves may be combined with all other features according to the different embodiments of the rotor 10, as have been explained for example by way of FIGS. 2 to 6. The groove courses and channel courses may be combined with the different bearing designs and designs of the rotor outer periphery.

Additional or alternatively to the obliquely running groove on the inner periphery of the can 14, one may also design a corresponding groove on the outer periphery of the rotor 10. Such a groove may either extend parallel to the rotation axis X or also be wound in a helical manner, as the groove 42. However, preferably several grooves are uniformly distributed on the periphery of the rotor with the arrangement of the grooves on the rotor, in order to prevent imbalances.

The grooves on the outer periphery of the rotor 10 or on the inner periphery of the can 14, as explained, run inclined in a helical manner according to a preferred embodiment, and the grooves thereby may run around in an inclined manner to the left or to the right. If several grooves are provided on the rotor 10 or the can 14, then these grooves may either run inclined in the same direction or also in different, i.e., opposite directions, so that for example one groove describes a left-handed thread and the other groove a right-handed thread. The bleeding may be further improved by way of this.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-16. (canceled)

17. A pump assembly with an electric drive motor, comprising a rotor (10) designed as a permanent magnet rotor, wherein the rotor (10), at least in a portion of its axial extension (X), is designed as shaftless and completely of a magnetizable material, and wherein magnet poles of the rotor (10) are formed by magnetization of the magnetizable material.

18. The pump assembly according to claim 17, wherein the rotor (10) is completely formed as one piece from the magnetizable material.

19. The pump assembly according to claim 17, wherein the magnetizable material forms at least one bearing surface (22, 24) of the rotor (10) in a radial and/or axial direction.

20. The pump assembly according to claim 17, wherein at least one bearing surface (22, 24) of the rotor (10) is formed by a bearing bush (26, 28) connected to the magnetizable material, and wherein the bearing bush (26, 28) is pressed with the magnetizable material of the rotor (10).

21. The pump assembly according to claim 19, wherein stationary bearing surfaces (18, 20) of a ceramic material or carbon, which cooperate with the bearing surfaces (22, 24) of the rotor (10), are arranged in the pump assembly.

22. The pump assembly according to claim 19, wherein a radially acting bearing surface (22, 24) of the rotor is designed in a manner such that an annular recess (32, 34) is formed on at least one axial end of the bearing surface (22, 24) on the outer periphery of the rotor (10).

23. The pump assembly according to claim 17, wherein a shaft stub is arranged on at least one axial end of the rotor (10), the shaft stub extending away from the end.

24. The pump assembly according to claim 17, wherein the magnetizable material is a ferrite material.

25. The pump assembly according to claim 17, wherein at least one radially and/or axially extending bleed channel (36, 44) is formed in the rotor (10).

26. The pump assembly according to claim 17, wherein at least one bleed groove is formed on an outer periphery of the rotor, which extends in a helical manner over the periphery of the rotor.

27. The pump assembly according to claim 17, wherein the drive motor is designed as a canned motor with a can (14) of stainless metal or plastic.

28. The pump assembly according to claim 27, wherein the can (14) on its inner periphery comprises a bleed groove (42) extending in a helical manner.

29. The pump assembly according to claim 17, wherein only a region of the rotor (10) lying radially opposite a stator (8) of the drive motor has the magnet poles formed by magnetization.

30. The pump assembly according to claim 17, wherein the rotor (10), at an axial end (16), comprises a magnet pole of a rotation angle sensor, which is produced by magnetization of the magnetizable material.

31. The pump assembly according to claim 17, wherein the rotor (10) has a constant outer diameter over its entire axial length.

32. A permanent magnet rotor for a pump assembly with a drive motor, wherein the rotor (10), at least in a part region of its axial extension (X), is designed as shaftless and completely of a magnetizable material, and wherein magnet poles of the rotor (10) are formed by magnetization of the magnetizable material.
